(19) United States
(12) Patent Application Publication
(10) Pub. No.: US 2014/0073300 A1
(43) Pub. Date: Mar. 13, 2014

(54) Managing Telecommunication Services using Proximity-based Technologies

(71) Applicants: Michael Leeder, Stittsville (CA); Richard C. Taylor, Manotick (CA)

(72) Inventors: Michael Leeder, Stittsville (CA); Richard C. Taylor, Manotick (CA)

(73) Assignee: GENBAND US LLC, Frisco, TX (US)

(21) Appl. No.: 13/609,083

(22) Filed: Sep. 10, 2012

(51) Int. Cl. H04B 7/24; H04W 4/16; H04B 5/00

(52) U.S. Cl. 455/416; 455/41.2; 455/41.1

(57) ABSTRACT

Systems and methods for managing telecommunication services using proximity-based technologies are described. In some embodiments, a method may include detecting, by a first communication device (e.g., a laptop computer, a netbook computer, a tablet computer, a cellular phone, a smartphone, etc.), a proximity device (e.g., a Radio-Frequency Identification (RFID) tag, a Near Field Communications (NFC) tag, etc.) coupled to or integrated within a second communication device. The method may also include triggering an operation configured to manage a telecommunication service based, at least in part, upon the detection of the proximity device. In some implementations, the operation may be configured to reduce a number of manual operations that would otherwise be involved in managing the telecommunication service. For instance, in a non-limiting example, the operation may cause a routing of a communication directed at the first communication device to the second communication device. Numerous other telecommunication services are described herein.

### TECHNICAL FIELD

This disclosure relates generally to telecommunications, and more specifically, to systems and methods for managing telecommunication services using proximity-based technologies.

### BACKGROUND

The following discussion sets forth the inventors' own knowledge of certain technologies and/or problems associated therewith. Accordingly, this discussion is not an admission of prior art, and it is not an admission of the knowledge available to a person of ordinary skill in the art.

Telecommunication services are becoming increasingly mobile due to the widespread use of portable consumer devices such as cellular phones, smartphones, tablet computers, netbooks, laptops, etc. To the telecommunications industry, the user experience afforded by these mobile devices has proven to be of critical importance. For example, the proliferation of smartphone systems has created, among many users, an expectation that all interactions with such devices should take place through simple, “one-touch” interfaces. However, certain enhanced telecommunication services (e.g., call forwarding, call grabbing, teleconferencing, etc.) still require multi-step configurations, lengthy passwords, and/or multiple levels of interface navigation. As a result, users are less and less likely to utilize these services, which can translate into lower revenues for a service provider.

To illustrate some of difficulties in facilitating the use of enhanced telecommunications services, as identified by the present inventors, consider services such as “find-me” and “follow-me” calling. Find-me and follow-me are two call forwarding services that are commonly used in conjunction with each other. A find-me service allows the user to receive calls at any location, whereas the follow-me service allows the user to be reached at any of several phone numbers. Typically, a user is assigned a virtual phone number. When that number is dialed, the system routes the call through a user-defined list of numbers. The numbers may be called simultaneously or sequentially, either in a preferred order or in accordance with the user's scheduled activities and locations. Once the list has been called and no connection made, the system may route the call to voice mail, for example. Thus, with these services, the user pre-defines a profile with many rules about where an incoming call to a given number should be routed. However, these rules are traditionally defined in advance, and are then applied without consideration of the user's actual environment and/or the communication devices available to them at their present time. Also, creating and changing these find-me and follow-me rules has traditionally requires the user to navigate numerous interfaces and manually input information to define the numbers to which incoming calls should be routed at different times of the day, different days of the week, etc.

Other technological advances have also failed to facilitate the implementation and/or use of enhanced telecommunication services. For example, Bluetooth® technology now allows a smart phone to provide an audio interface through a separate headset device that has been previously paired with the phone. Also, Near Field Communications (NFC) tags may allow smart phones to change one or more its internal, local settings (e.g., ring volume, vibrate, etc.). None of these technologies, however, has been useful in reducing the number of multi-step configurations, passwords, or levels of interface navigation that are typical of enhanced telecommunication services.

Accordingly, to address these, and other concerns, the inventors hereof have developed systems and methods for providing and receiving telecommunication services using proximity-based technologies, as described in detail below.

### SUMMARY

Embodiments disclosed herein are directed generally to systems and methods for managing telecommunication services using proximity-based technologies. As described herein, such management of telecommunication services using proximity-based technologies may, in certain embodiments, include one or more of the provision and/or receipt of telecommunication services, including without limitation enhanced telecommunication services, management of the provision and/or receipt of such services, selecting/configuring user communication profiles, transferring, forwarding, and/or migrating calls from one device to another, activating rules for forwarding calls that are incoming to one device to another device, etc.

In an illustrative, non-limiting embodiment, a method may include detecting, by a first communication device, a proximity device coupled to or integrated within a second communication device. The method may also include triggering an operation configured to manage a telecommunication service based, at least in part, upon the detection of the proximity device. In some cases, the first communication device may include, for example, a laptop computer, a netbook computer, a tablet computer, a cellular phone, or a smartphone. Meanwhile, the proximity device may include, for example, a Radio-Frequency Identification (RFID) or Near Field Communications (NFC) tag. Moreover, the operation may be configured to reduce, minimize, or eliminate a number of manual operations that would otherwise be involved in managing the telecommunication service.

In some implementations, the operation may be configured to cause a routing of a communication directed at the first communication device to the second communication device. For instance, the communication may be in progress via the first communication device at a time prior to the first communication device detecting the proximity device, and the communication may continue via the second communication device after the routing. The method may then include causing the routing to cease, at least in part, in response to an event selected from the group consisting of: a determination that the first communication device no longer detects the proximity device, and a subsequent detection by the first communication device of the proximity device, and a manual selection by a user of the first communication device.

In some cases, the proximity device may be located in a vehicle, the first communication device may be located closer to a driver's position within the vehicle than the second communication device, and the second communication device may be located closer to a passenger position in the vehicle than the first communication device.

In other implementations, the operation may be configured to cause a routing of a communication directed at the second communication device to the first communication device. Again, the communication may be in progress via the second communication device at a time prior to the first communication device detecting the proximity device, and the communication may continue via the first communication device after the routing. In yet other implementations, the operation may be configured to cause the one or more application servers to retrieve conference call information associated with a user of the first communication device, the conference call information including a conference bridge and passcode, such that the operation may be further configured to cause the one or more application servers to cause a conference call to be established via the second communication device using the conference bridge and passcode.

In some cases, detecting the proximity device may include receiving telecommunication configuration information from the proximity device, the telecommunication configuration information including an identification code and a service code. Further, triggering the operation may include causing the identification code to be validated against at least one piece of information selected from the group consisting of: an identification of the first communication device, an identification of a user of the first communication device, and an identification of the second communication device, and transmitting the service code to one or more application servers remotely located with respect to the first communication device, the service code configured to manage an aspect of the telecommunications service provided, at least in part, by the one or more application servers. For example, to cause the identification code to be validated, the method may include transmitting the identification code and the selected piece(s) of information to the one or more application servers, the one or more application services configured to attempt to match the identification code to the selected piece(s) of information.

In another illustrative, non-limiting embodiment, a tangible computer-readable storage medium may have program instructions stored thereon that, upon execution by a computer system, cause the computer system to receive telecommunication configuration information from a mobile communication device, the telecommunication configuration information obtained by the mobile communication device from a proximity device located within range of the mobile communication device, the mobile communication device and the proximity device remotely located with respect to the computer system, the telecommunication configuration information including a service code and an identification code. The computer system may also modify of an aspect of a telecommunications service provided to the mobile communication device based, at least in part, upon the service code and the identification code, where the service code may be configured to reduce a number of operations by the user of the mobile communication device that would otherwise be involved in the modification.

In some implementations, to modify the aspect of the telecommunication service, the program instructions may further cause the computer system to request that a communication directed at the mobile communication device be routed to another communication device. Additionally or alternatively, the program instructions may cause the computer system to request that a communication directed at another communication device be routed to the mobile communication device. In other implementations, the program instructions may cause the computer system to request (a) retrieval of conference call information associated with a user of the mobile communication device, and (b) establishment of a conference call via another communication device using the conference call information.

In yet another illustrative, non-limiting embodiment, a proximity device may include a memory configured to store telecommunication configuration information, the telecommunication configuration information including an identification code and a service code, the identification code and the service code retrievable by a communication device within range of the proximity device, the identification code usable by the communication device to validate at least one piece of information selected from the group consisting of: an identification of the communication device and an identification of a user of the communication device, the service code configured to cause a modification of an aspect of a telecommunications service provided at least in part by one or more application servers to the communication device, the one or more application servers remotely located with respect to the communication device.

For example, the service code may be configured to cause the one or more application servers to route a communication directed at the communication device to another communication device without manual input from the user of the communication device, or to cause the one or more application servers to route a communication directed at the other communication device to the communication device without manual input from the user of the communication device. Additionally or alternatively, the service code may be configured to cause the one or more application servers to retrieve conference call information associated with the user of the communication device and to cause the one or more application servers to establish a conference call via another communication device using the conference bridge and passcode without manual input from the user of the communication device.

### BRIEF DESCRIPTION OF THE DRAWINGS

Reference will now be made to the accompanying drawings, wherein:

FIG. 1 is a block diagram of an illustrative telecommunications environment according to some embodiments.

FIG. 2 is a block diagram of a client application executable by a communication device according to some embodiments.

FIG. 3 is a block diagram of one or more application servers according to some embodiments.

FIG. 4 is a flowchart of a method of receiving telecommunication services using proximity-based technologies according to some embodiments.

FIG. 5 is a flowchart of a method of providing telecommunication services using proximity-based technologies according to some embodiments.

FIG. 6 is a message flow diagram for a method of changing telecommunications settings according to some embodiments.

FIG. 7 is a screenshot of a communication device's Graphical User Interface (GUI) according to some embodiments.

FIG. 8 is a message flow diagram of a call grabbing method according to some embodiments.

FIG. 9 is a block diagram of a computer system configured to implement various systems and methods described herein according to some embodiments.

### DETAILED DESCRIPTION

Embodiments disclosed herein are directed generally to systems and methods for managing telecommunication services using proximity-based technologies. In some implementations, managing telecommunication services may include providing and/or receiving those services, as well as managing the provisioning and/or receipt of such services (e.g., selecting and/or configuring user profiles, transferring calls from one communication device to another, activating rules for forwarding calls that are incoming to one device to another device, etc.). The term “telecommunications,” as used herein, is intended to encompass voice communications or telephony, as well as other forms of communications (e.g., video communications, videoconferencing, instant messaging or IM, Short Messaging Service or SMS, emails, etc.) that may take place electronically, for example, over wireless networks, circuit-switched networks, packet-switched networks, or any combination thereof.

In some embodiments, the various systems and methods described below may be particularly well suited for deployment in a business or office setting. It should be understood, however, that some of the examples described below make specific reference to an office for sake of illustration only. The same or similar devices and/or techniques may find applicability in many other types of settings (e.g., home, shopping malls, airports, hospitals, prisons or jails, airplanes, automobiles, etc.). For example, these devices and/or techniques may be applied as “enterprise” solutions, such as across university/college campuses, business or other organization campuses, governmental campuses, and/or other geographically-distributed locales, where the proximity-based technologies described herein may be deployed for various communication devices that are made available across the enterprise's campus(es).

Telecommunication users often encounter a number of different communication devices that may be available in a given environment or across different environments. For instance, as users go about their daily lives, they often encounter such communication devices as a mobile telephone, a home landline telephone, an office telephone, an office computer, a teleconferencing device, a home computer, a home landline telephone, etc. Thus, these users may desire to manage their communications differently depending on the communication devices available to them in a given environment at a certain time. However, as mentioned above, performing various enhanced telecommunication services (e.g., call forwarding, call grabbing, teleconferencing, etc.) that may be desired for managing communication in different environments traditionally requires multi-step configurations, lengthy passwords, and/or multiple levels of interface navigation; and therefore is not convenient, efficient, and/or user friendly to perform. For instance, a user may conduct a call using their mobile telephone while they are traveling to work, and then they may desire to migrate that call from their mobile telephone to their office telephone when they arrives at their office. Conversely, when a user leaves their office, they may whish to conduct calls or other communications (e.g., ongoing or future telephone calls) directed to their desk phone using their mobile telephone. However, performing such call migration operations, for example, may require many manual acts by the user. Other examples of operations that traditionally involve manual commands include, but are not limited to, having a user's profile be applied to a new communication device that they encounter in a given environment, activating call forwarding from one communication device to a new communication device that they encounter in a given environment, etc.

Accordingly, in some embodiments, the systems and methods described herein may provide an enhanced end-user experience, for example, by enabling contextual information (e.g., location, access points, presence and time, etc.) to be used to automatically configure and/or activate telecommunication services, thus reducing, minimizing, or eliminating the amount of user interaction otherwise required to enable those services. For example, in some cases, a user may simply touch an NFC tag or the like to initiate and control complex communication operations, which would otherwise require cumbersome user interactions. The systems and methods described herein may also allow users manage their various communication roles by configuring different personas and then relying upon contextual information to select which of these different personas should be active at any given time. These systems and methods may also make input intensive communication operations possible on simple consumer electronic devices without keyboards or dial pads (e.g., TV remotes, automobile electronics, home security systems, etc.), and may simplify user experience for people with visual impairments. These systems and methods may also enable new categories of “flash-mob communications” and social network “check-in,” which are not practical with existing communication technologies (e.g., NFC check-in to communication groups when entering a sports arena, etc.). Moreover, some of the technologies described herein may allow NFC-based triggering to be applied to legacy phones (i.e., without a need to upgrade desk phones, etc.).

Furthermore, in a growing number of states, hands free systems are now required in order to allow users to operate mobile devices while driving an automobile. Such a precaution is intended to reduce accidents caused by driver distraction. However, these systems are largely ineffective with regard to texting (e.g., “texting-while-driving”) and other forms of communication. Therefore, the systems and methods described herein may further enable a context-based filtering of communication sessions for users determined to be driving.

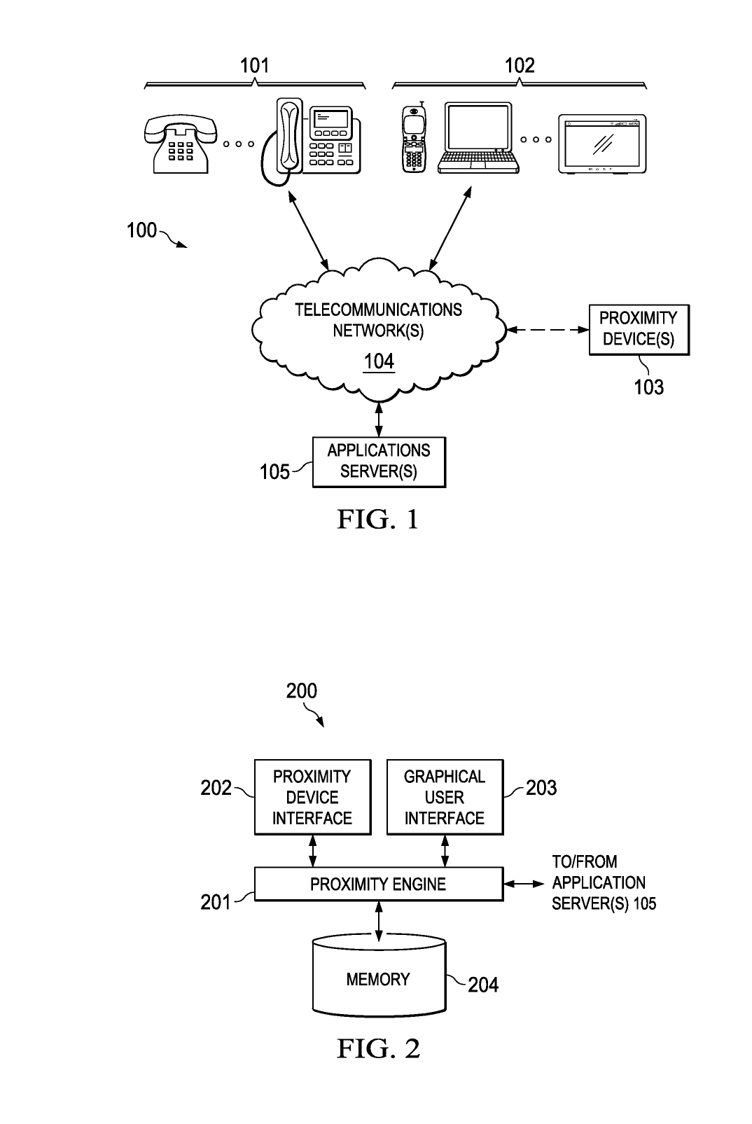

Turning now to FIG. 1, a block diagram of telecommunications environment 100 is depicted according to some embodiments. As illustrated, one or more fixed communication devices 101 (e.g., analog telephones, digital telephones, teleconferencing systems, desktop computers, network appliances, etc.) and one or more mobile communication devices 102 (e.g., cellular phones, smartphones, tablet computers, netbooks, laptops, etc.) are coupled to telecommunications network 104. Generally speaking, fixed communication devices 101 typically spend the majority of their useful lives at a given physical locations (e.g., on a desk, in a conference room, etc.), whereas users often carry around their respective mobile communication devices 102 from place to place (e.g., in a pocket, briefcase, car, etc.).

In various embodiments, telecommunications network 104 may include one or more wireless networks, circuit-switched networks, packet-switched networks, or any combination thereof to enable communications between two or more of communication devices 101 and/or 102. For example, network 104 may include a Public Switched Telephone Network (PSTN), one or more cellular networks (e.g., third generation (3G), fourth generation (4G), Long Term Evolution (LTE) wireless networks, etc.), satellite networks, computer or data networks (e.g., wireless networks, Wide Area Networks (WANs), metropolitan area networks (MANs), Local Area Networks (LANs), Virtual Private Networks (VPN), the Internet, etc.), or the like. Furthermore, telecommunications network 104 may be coupled to one or more application servers 105.

Still referring to FIG. 1, one or more proximity devices 103 may be present within telecommunications environment 100. In general, a proximity device 103 may be a device operable to recognize and/or communicate certain information to another device that is placed within relatively close physical proximity of it. Examples of proximity devices 103 include, but are not limited to, Radio-Frequency Identification (RFID) tags or chips, Near Field Communication (NFC) tags or chips, wireless routers or access points (e.g., Wifi, etc.), Bluetooth® adaptors, or the like. In some embodiments, one or more of proximity devices 103 may be embedded into or integrated within one or more of communication devices 101 and/or 102. Additionally or alternatively, one or more of proximity devices 103 may be coupled to or disposed nearby one or more of communication devices 101 and/or 102 via an adapter, tag, etc.

In some embodiments, proximity devices 103 may be either active or passive devices. In the case of a passive proximity device 103 (e.g., an unpowered RFID or NFC tag), for example, the device may be coupled to or disposed nearby one or more of communication devices 101 and/or 102 (e.g., an NFC tag attached to a sticker may be adhered to a fixed telephone or conferencing system). Conversely, an active proximity device 103 may receive electrical power from one or more of communication devices 101 and/or 102 (e.g., a Bluetooth® adaptor coupled to a processor-based device via a Universal Serial Bus (USB) port or the like) or from other suitable source (e.g., a wireless access point plugged into an electrical wall socket, a battery, etc.).

As discussed in more detail below, proximity device(s) 103 may each store or encode certain telecommunication configuration information, and that configuration information may be transmitted to application server(s) 105 in order to activate, deactivate, and/or modify the configuration of one or more telecommunication services provided, at least in part, by one or more of network 104 and/or application server(s) 105 to one or more users operating one or more of communication devices 101 and/or 102. For sake of illustration, Table I shows an example of telecommunication configuration information that may be stored in a tangible or non-transitory memory within or otherwise accessible to a given one of proximity devices 103.

TABLE I

| | |
|---|---|
| Identification Code | Service Code |

Parameter 1
Parameter 2
. . .
Parameter n

In some embodiments, the identification code may include an alphanumeric string that identifies a communication device 101 or 102 associated with a given proximity device 103. For example, the identification code may identify a given one of fixed communication devices 101 that would be activated or deactivated through the use of that particular proximity device 103 (e.g., in the case of an NFC sticker attached to an office phone, the identification code may identify that office phone). Additionally or alternatively, the identification code may include an alphanumeric string that identifies one or more of communication devices 101 and/or 102, and/or users that are authorized to use certain telecommunication configuration services (e.g., still in the case of an NFC sticker attached to an office phone, the identification code may identify one or more mobile phones that are allowed to route a telephone call to or from that office phone).

In general, the amount of information that may be stored within a memory of proximity device 103 may depend upon the type of proximity device. For instance, with respect to NFC tags, type 1 tags (ISO 14443A) are capable of storing up to 96 bytes of information (expandable to 2 kilobytes), type 2 (ISO 14443A) may store up to 48 bytes (also expandable to 2 kilobytes), type 3 (Sony® Felica) may store up to 2 kilobytes, and type 4 (ISO 14443A and B) may store up to 32 kilobytes.

In various implementations, the identification code may include a Media Access Control (MAC) address, an International Mobile Equipment Identity (IMEI), an International Mobile Subscriber Identity (IMSI), Mobile Subscriber Integrated Services Digital Network-Number (MSISDN) or the like. Additionally or alternatively, the identification code may include a username or an e-mail address. Meanwhile, the service code may indicate a telecommunication service (e.g., call forwarding, call grabbing, automated teleconferencing setup, etc.) to be managed or configured, and parameters 1-n may include one or more configuration options or settings for the identified service (e.g., one or more phone numbers or device identifiers where an ongoing or subsequent communication may be forwarded to, communication protocol, electronic signatures, etc.).

In some cases, at least a portion of the data stored within proximity device(s) 103 may be openly readable by any capable mobile communication device 102. In some implementations, identification and service codes stored in proximity device(s) 103 may be arbitrary values that do not reveal the identity of a user, operator, or other credential information—i.e., it may be the responsibility of mobile communication device 102 and/or of a corresponding service to determine that a given user is allowed to access a particular device or service before invoking the corresponding service. In other implementations, if extra security is required, only identification and/or service code(s) may be stored in the proximity device 103, and additional data may be stored within a secure network server. In yet other implementations, the telecommunication configuration information stored in proximity device(s) 103 may be at least partially encrypted using a suitable encryption technique.

In some cases, the telecommunication configuration information may not be stored fully (or at all) in proximity device 103, but instead the proximity device may be able to access an external storage of information (e.g., storage in its associated communication device) and/or may simply communicate information that directs the communication device 102 to a server or other storage location where the configuration information is stored; and the storage option selected for a given implementation may depend, at least in part, on the amount of storage capacity of the proximity device 103.

When a passive proximity device provides its telecommunication configuration information to one or more of mobile communication devices 102, for example, communication device 102 may process the configuration information and/or transmit at least a part of that information to application server(s) 105 through its own connection to network(s) 104. Conversely, if an active proximity device provides telecommunication configuration information to communication device 102, proximity device 103 may itself be connected to telecommunication network(s) 104 (as indicated by the dotted line in FIG. 1), and proximity device 103 may therefore transmit the telecommunication configuration information to application server(s) 105 independently of, or in combination with, any other transmission(s) performed by mobile communication device 102.

FIG. 2 is a block diagram of example of a client application according to some embodiments. In some implementations, one or more of communication devices 101 and/or 102 may be capable of executing client application 200. For instance, client application 200 downloaded to or otherwise installed on communication device(s) 101 and/or 102 and stored to the communication device's memory for execution on one or more processors of such communication device(s) 101 and/or 102 to perform one or more operations described further herein. As shown, proximity engine 201 is coupled to proximity device interface module 202 and to Graphical User Interface (GUI) module 203.

For ease of explanation, when a communication device is executing client application 200, it may be referred to as a “host” communication device. Conversely, when a communication device includes or is otherwise coupled to a proximity device 103, it may be referred to as a “proximate” communication device. It should be noted, however, that the same communication device may act as a host and as a proximate communication device at different times depending upon its environment and/or context—that is, the roles of “host” and “proximate” communication devices may change over time. For instance, a host communication device 102 may detect a proximate device 103 and migrate a call to the associated proximate communication device 101 (or otherwise have service configurations modified) so that the proximate communication device 101 assumes the role of host, at least temporarily.

Accordingly, the use of the labels “host” and “proximate” in these examples are not intended to be fixed, static labels for each device.

In general, proximity device interface module 202 may be configured to communicate with—i.e., receive information from and/or transmit information to—a proximity device 103 shown in FIG. 1. Such communication may include information identifying a host communication device 102 upon which client application 200 may be running, information identifying a proximate communication device 101 with which proximity device 103 may be associated, information identifying a particular user, etc. GUI module 203 may be configured to present a user interface to a user (e.g., on a display of the host communication device 102 on which client application 200 may be running), which may be used as described further herein for interacting with a user. As an example, in certain embodiments, the GUI 203 may present an interface to enable a one-touch migration of a call from the host communication device 102 on which client application 200 is running to a proximate communication device 101 associated with a proximity device 103. Proximity engine 201 may be configured to manage certain telecommunication services based on its communication with proximity device interface module 202, GUI module 203, and/or application server(s) 105, as described further herein.

For example, when proximity device 103 is an NFC tag or the like, proximity device interface module 202 may allow proximity engine 201 to control one or more electronic circuits within host communication device 102 that are capable of interrogating the NFC tag and of retrieving telecommunication configuration information (or any other data) stored in the NFC tag. As such, proximity device interface module 202 may include an NFC Application Programming Interface (API), a Wifi API, or other suitable technologies. GUI module 203 may be configured to provide a visual display to a user of the host communication device 102 upon a screen (e.g., a touchscreen) and/or to receive feedback from the user. For instance, GUI module 203 may be implemented using the iOS® Software Development Kit (SDK), Android™ SKD, Java™, AJAX, Adobe® Flex®, Microsoft®.NET, or other suitable technologies.

Proximity engine 201 may be configured to communicate with application server(s) 105 shown in FIG. 1 to perform one or more proximity-based telecommunication configuration operations. To that end, proximity engine 201 may include one or more routines written in any suitable programming or scripting language (e.g., C, C++, C#, Java™, JavaScript™, Perl, etc.). For example, upon execution by host communication device 102, engine 201 may be configured to receive an indication from proximity device interface module 202 that host communication device 102 (on which client application 200 is running) is within range of a given proximity device 103 and/or it may receive telecommunication configuration information stored in proximity device 103 through proximity device interface module 202. Memory 204 is coupled to proximity engine 201, in this example, and it may allow proximity engine 201 to access certain information stored to such memory 204 that enables one or more decryption, validation, and/or authentication transactions. For example, memory 204 may be used to used to store activation state information (e.g., when a user swipes the NFC tag on a phone (e.g., when they arrive at their office), the current communication state may be saved so that it may be reinstated the next time the user swipes the same (or a different) NFC tag (e.g., when the user leaves the office). These, and other operations, are described in more detail in connection with FIGS. 4 and 5.

In some embodiments, the modules or blocks shown in FIG. 2 may represent sets of software routines, logic functions, and/or data structures that, when executed by a processor-based device, perform specified operations. Although these modules are shown as distinct logical blocks, in other embodiments at least some of the operations performed by these modules may be combined in to fewer blocks. That is, while shown as distinct blocks in FIG. 2 for ease of illustration and discussion purposes, the various blocks may not be separate, distinct identifiable blocks or modules in a given implementation. For example, in some cases, proximity device interface module 202 and/or GUI module 203 may be combined with proximity engine 201. Conversely, any given one of modules 201-204 may be implemented such that its operations are divided among two or more logical blocks. Although shown with a particular configuration, in other embodiments these various modules or blocks may be rearranged in other suitable ways as will be readily apparent to those of ordinary skill in the art in light of this specification.

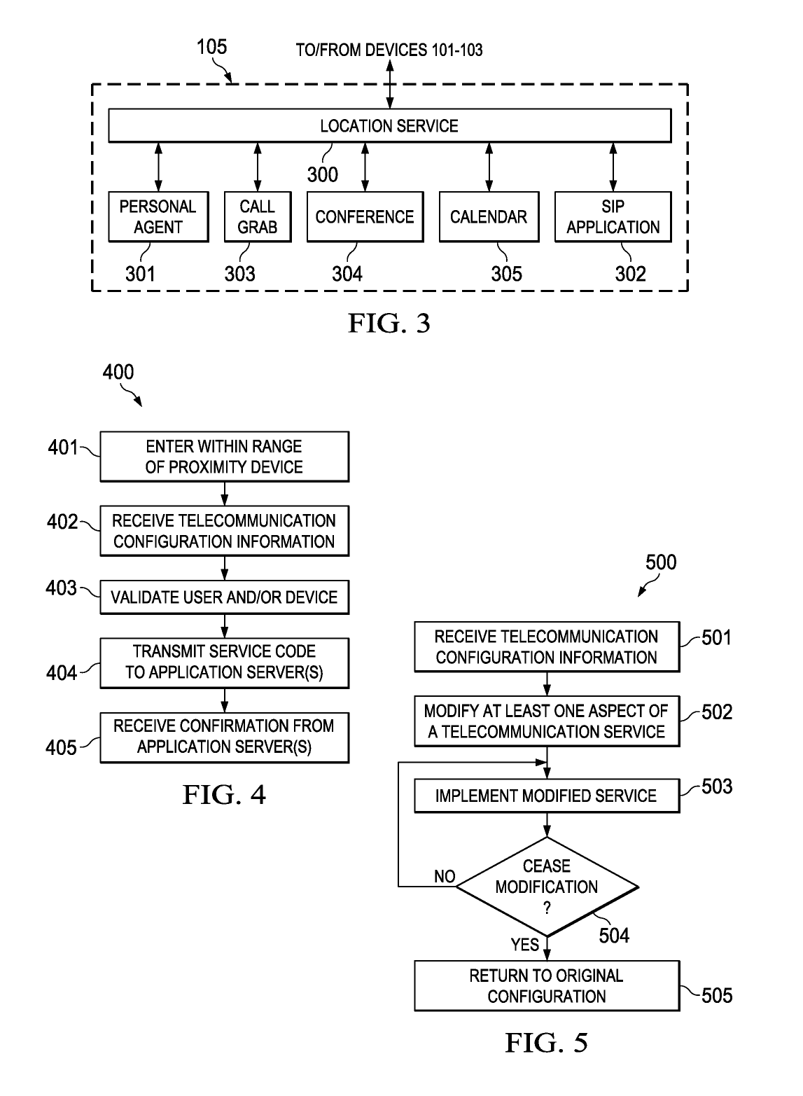

FIG. 3 is a block diagram of an example of application server(s) 105 shown in FIG. 1 according to some embodiments. As illustrated in this example, location service 300 is operably coupled to personal agent 301, Session Initiation Protocol (SIP) Application (AP) server (SIP AP) 302, call grabbing service 303, conferencing service 304, and calendar service 305. It should be noted, however, that other embodiments may be implemented in environments using technologies and/or protocols other than SIP. Location service 300 may be configured to ascertain a current location or device identification of an active device operated by a user. For example, location service 300 may use information obtained through the proximity devices 103, Global Positioning Satellite (GPS) coordinates, or other location technologies to determine the position of such a device. In some cases, location service 300 may also be configured to interact with personal agent 301 to validate or authorize a change of location (or device) requested by a particular user.

Personal agent 301 may be configured with one or more rules, preferences, profiles, or personas that may be activated by users upon a change of location. For example, personal agent 301 may allow users to define/configure their call handling rules (e.g., set up calling preferences, call forwarding rules, user profile parameters, etc.), for instance, via a web interface or the like. A user may provision, for instance, their preferences associated with different “personas” (e.g., when using work profile, send missed calls to VM; when using Personal profile, send me a text message when I miss a call). When a user changes their calling rules/preferences, these rules may then be made available to SIP AS 302, so that they may be applied to the user's communications (e.g., when a subsequent call arrives).

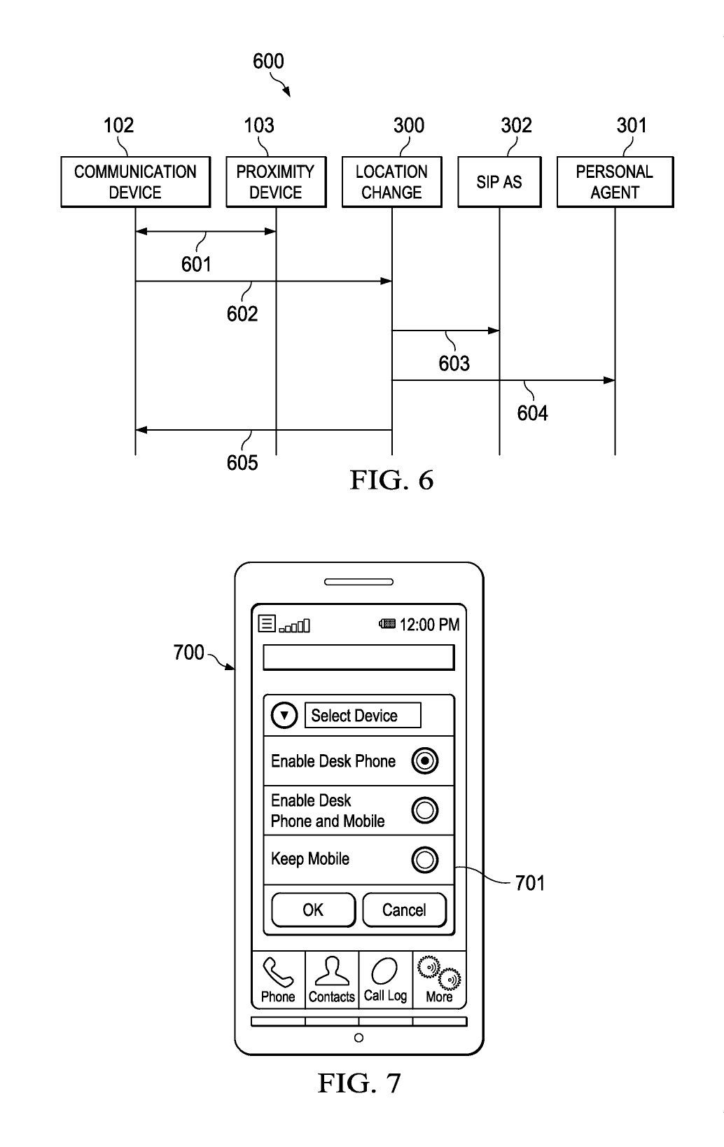

SIP AS 302 may include a call/session and application-processing engine. It provides real-time telephony services to individual subscribers, such as call setup, dial plans, call forwarding, user presence services, user profile, billing/charging, etc. Moreover, SIP AS 302 may be configured to route one or more calls or other communications to one or more communication devices in order to satisfy the rules activated through personal agent 301. Call grab service 303 may be configured to facilitate the tear down and establishment of leg(s) of ongoing communication(s). Calendar service 305 may be configured to store teleconference information for one or more users, and teleconference service 304 may be configured to establish teleconferencing communications using the stored teleconference information. These, and other operations, are described in more detail in connection with FIGS. 6-8.

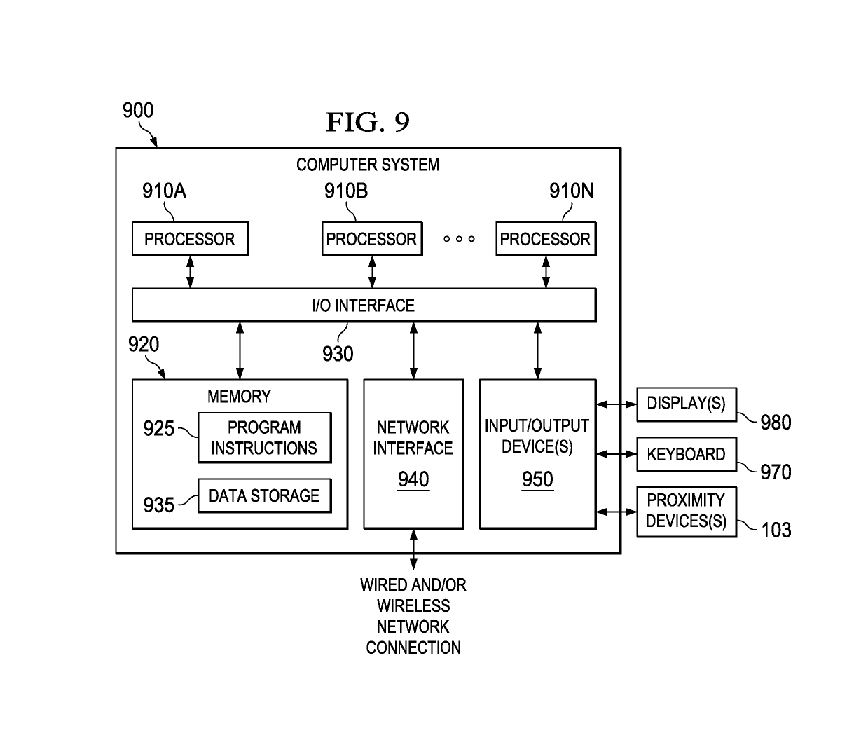

In some embodiments, each of blocks 300-305 may be implemented as a separate hardware server (for example, as shown in FIG. 9). In other embodiments, however, two or more of blocks 300-305 may be implemented as services provided by the same hardware server (e.g., the call grabbing service 103 may be provided by a SIP application server). For example, the software-centric GENBAND GENiUS™ platform provides a unified switching and networking platform supporting multipurpose telecommunications solutions, including cloud-based and multimedia applications, local and interconnect call control, session border control, etc. that is capable of accommodating one or more of services 300-305. Furthermore, it should be noted that servers and/or services 300-305 are shown only to provide examples of enhanced telecommunication services. In other implementations, other services may be added and/or removed from the set of application server(s) 105 shown in FIG. 3. Also, it should be noted that one or more of servers and/or services 300-305 may be accessible to one or more of devices 101-103 directly and/or while bypassing location service 300. For example, in some implementations, communication device 102 may access call grab service 303 without otherwise accessing location service 300.

FIG. 4 is a flowchart of an example of a method of receiving telecommunication services using proximity-based technologies according to some embodiments. In some implementations, method 400 may be performed, at least in part, by a host communication device 102 executing client application 200. At block 401, method 400 includes receiving an indication (e.g., via proximity device interface module 202) that host communication device 102 is within range of a given proximity device 103 (e.g., in the order of centimeters when proximity device 103 is an NFC tag, in the order of several meters when device 103 is a Wifi router, etc.). In some cases, after receiving such an indication, proximity engine 201 may provide a user of host communication device 102 with a graphical representation of that indication through GUI module 203 (e.g., via a display of such communication device 102) and/or it may request that the user provide guidance as to how to proceed, for example, as shown in FIG. 7. Additionally or alternatively, at block 402, method 400 includes receiving telecommunication configuration information stored in proximity device 103 (e.g., through proximity device interface module 202).

At block 403, method 400 includes decrypting, validating, and/or authenticating communication device 102 and/or its user, in this example. For instance, proximity engine 200 may, in certain embodiments, compare the identification code of proximity device 103 with communication device and/or user identification stored in memory 204 to determine whether the user and/or device are authorized to invoke a modification of a telecommunication service. Additionally or alternatively, proximity engine 200 may transmit the identification code from proximity device 103 and/or the identification stored in memory 204 to application server(s) 105 for remote decryption, validation, and/or authentication operation(s).

At block 404, method 400 includes transmitting a service code obtained as part of the telecommunication configuration information from proximity device 103 to application server(s) 105. As previously noted, such a service code may identify one or more of application server(s) 105 and/or one or more telecommunication services to be reconfigured. In some embodiments, a service code alone may be sufficient to cause a configuration of a particular service. In other embodiments, one or more parameters 1-n, also obtained from proximity device 103, may be transmitted to application server(s) 105 at block 404 to facilitate the configuration of the telecommunication service.

In some implementations, operations 401-404 may require no active involvement by a user of communication device 102 (other than having allowed communication device 102 to come into range of proximity device 103). For instance, the manual entry of information to and interaction with a “host” communication device and/or a “proximate” communication device that is required of the user for managing telecommunication services may be reduced, minimized, or eliminated. As such, from the end-user's perspective, reconfiguration of a telecommunication service (or performance of other management of telecommunication services) may be had with little to no interaction with communication device 102 (e.g., via a GUI, etc.). In other implementations, at block 405, method 400 may include receiving a notification from application server(s) 105 that a telecommunication service has been configured or is about to be configured. In the latter case, the user of communication device 102 may have an opportunity to confirm that such configuration is desired (e.g., via a touchscreen selection or the like presented by GUI 203). Even with such a confirmation operation, which does not always need to be invoked, method 400 may still cause a reduction in a number of operations by the user of communication device 102 that would otherwise be involved in traditional techniques for causing the configuration of the telecommunications service.

FIG. 5 is a flowchart of an example of a method of providing telecommunication services according to some embodiments. In some implementations, method 500 may be performed, at least in part, by one or more of application server(s) 105 and/or service(s) 300-305. The operations described below may be triggered, for instance, upon a host communication device 102 entering within range of proximity device 103 associated with a proximate communication device 101 of FIG. 1. At block 501, method 500 includes receiving telecommunication configuration information (e.g., identification code(s), service code(s), parameters 1-n, etc.) from host communication device 102 and/or from a proximate device (e.g., one of communication devices 101) having proximity device(s) 103 coupled to or integrated therewith. In some cases, still at block 501, method 500 may include decrypting, validating, and/or authenticating host communication device 102 and/or its user. At block 502, method 500 includes configuring, re-configuring, or modifying at least one aspect of a telecommunication service. For example, application server(s) 105 may initiate a call forwarding, call grabbing, or automated teleconference setup operation(s), which are then implemented by at least one of network(s) 105 and/or application server(s) 105 at block 503.

At block 504, method 500 includes determining whether the user of host communication device 102 has authorized the modification or whether the configuration is to be restored back to its original settings. Additionally or alternatively, a timeout or other event (e.g., termination of an ongoing communication) may trigger a restore operation. If it is determined in block 504 that the modification is to proceed (e.g., is authorized and not terminated or prevented by some event), then application server(s) 105 may continue implementing the modified or reconfigured telecommunication service at block 503. Otherwise, at block 505, application server(s) 105 and/or service(s) 300-305 may return the telecommunication service to its original configuration (e.g., by causing call forwarding to cease, etc.). In some embodiments, changing the configuration of the service or restoring it to its original configuration may involve storing information defining the configuration to application server 105 and/or within communication device(s) 101 and/or 102.

As explained above, some of the systems and methods described herein provide techniques for using proximity-based communications technology to simplify and enhance the experience of users of telecommunication services. In certain embodiments, when an authorized communication device (e.g., a mobile phone) is brought into close proximity with an NFC tag, for example, the communication device is able to read the data stored in the NFC tag and use this information to validate the user, identify an associated communication service, and/or to automatically initiate that service without further user intervention (or, in some embodiments, with only minimal intervention, such as a one-touch approval interaction); thus providing mechanisms to simplify services that would otherwise require multiple user interactions (e.g., manual entry of codes, etc.) into a single phone swipe or touch operation.

In some implementations, a proximity device (e.g., an NFC tag) may be associated with the communication device that is being controlled or enhanced. This may include, for instance, attaching an NFC sticker tag to the side of a desk phone, attaching NFC tags to employees' security badges, embedding tags in keychain fobs or desk phones or other consumer electronic devices that support NFC tag emulation. For example, in an illustrative implementation, a user may touch their NFC-enabled mobile phone (or other NFC-enabled device) to an NFC tag (e.g., attached to office desk phone). The mobile phone may read the NFC tag data. The mobile phone may validate that the user is authorized to use the desk phone, and if so, it may use a service code to identify a predetermined service (e.g., call migration, etc.). If any parameters are present in the tag, the user's mobile phone may also retrieve those as input the to the service invocation. Then, the mobile phone may create and transmit (e.g., to an application server 105) a service invocation request based, at least in part, upon the NFC tag data. The service request may take different forms, including internal Application Programming Interface (API) call, remote API call (e.g., Representational State Transfer or REST invocation), remote message protocol (e.g., SIP), etc. The corresponding service provided by a local or a remote application server may receive the service invocation request, validate that the user is authorized to use the service, and extract the service code and other parameters from the service invocation request—which may then use to invoke the associated services on behalf of the user. After the service configuration or implementation occurs, the service may respond back to the user's mobile device with a status message (e.g., successful, error message, warning, etc.).

Similar techniques may be employed in a number of other illustrative implementations. For example, in one such implementation, using a mobile device to touch an NFC tag attached to a desk phone may result in an active call or messaging session on the desk phone to be transferred to the mobile (thus implementing a call grabber service without entering service codes or numbers). Also, a user may touch NFC tags to activate specific user personas or profiles (e.g., touch tag at work to activate “Office” persona and services). Tags may also be used to allow people with limited mobility or vision impairment to initiate communications without dialing (e.g., NFC fob to call home, NFC fob for emergency services, etc.). In some cases, a single NFC tag touch may invoke multi-component services (e.g., setup up multi-media conference with a single NFC tag (e.g., conference bridge, web collaboration, electronic whiteboard, video feed, etc.). Furthermore, a user may allow his or her phone to touch an NFC tag to configure or enable specific call routing and disposition profiles, to enable/disable call forwarding, to switch phone to in-car settings, to trigger personalized services on shared devices, to automatically join a previously scheduled conference call, etc. In certain embodiments, one or more (or all) of these settings/configurations may be based, at least in part, on the specific proximity device that is engaged (i.e., that the user touches with his/her mobile phone). For instance, a proximity device located in a car may be configured to transmit information to a host communication device that has engaged it indicating that the configuration should be changed to in-car settings, etc.

FIG. 6 shows a message flow diagram for a method of changing telecommunications settings according to some embodiments. Assume, for purposes of discussion of this exemplary embodiment, that a user's desk phone (e.g., fixed communication device 101) has been previously registered with a SIP AS (e.g., element 302 in FIG. 3), but that the SIP AS server is configured to not send incoming telephone calls to that device. (In other implementations, however prior registration may not be necessary.) Then, further assume that a user enters his/her office and holds his/her smartphone (e.g., mobile communication device 102) against an NFC sticker (e.g., proximity device 103) on or near the desk phone, thus triggering the communication of message(s) 601 between the user's smartphone (e.g., communication device 102) and the NFC sticker (e.g., proximity device 103). A mobile client application (e.g., such as client application 200 in FIG. 2) executing on the user's smartphone may read a <phone tag ID> (e.g., the identification and security code portions of the telecommunication configuration information) stored in the NFC tag, and the client application (e.g., proximity engine 201) may determine (e.g., directly or by consulting a remotely located authentication server and/or authentication database) that the read phone tag identifies a communication device (e.g., the user's desk phone) that belongs to the user or that the user is otherwise authorized to use. In some cases, the client application may (via GUI module 203) then present the user with a menu on the display of the user's smartphone such as, for example, device selection menu 701 shown in the exemplary phone screenshot 700 of FIG. 7 (an example of a communication device's GUI that may be presented by GUI module 203). In response, the user may select an option to “Enable Desk Phone.”

In the foregoing example, the selection to enable the user's desk phone may be achieved efficiently with minimal interaction required of the user (e.g., with a single touch of the “Enable Desk Phone” option presented on the user's smartphone display). In certain embodiments, the user's smartphone may be pre-configured to automatically perform one of the options (e.g., “Enable Desk Phone”), rather than presenting the user with the menu of options, thereby alleviating the user interaction that is required altogether. The user may, in certain embodiments, be able to set/change such pre-configuration option by interacting with a user interface provided by the client application 200, and the user's preferences in this regard may be stored to memory 204 and/or to external storage (e.g., application server 105). Also, in this example, should the user instead select “Enable Desk Phone and Mobile,” both communication devices may function concurrently (e.g., an incoming call into one device may ring both devices), whereas the “Keep Mobile” option may allow the user to maintain calls directed to the mobile device to continue to be handled by the mobile device.

Responsive to the selection of the “Enable Desk Phone” option in this example (either by the user's pre-configuration setting or by the user's interaction with GUI 701), the client application may send, via message 602, the <phone tag ID> to notify a Location Change service (e.g., element 300 in FIG. 3) about the change of location. Here, this “change of location” indicates that the user's mobile smartphone has engaged proximity device 103 that is associated with the user's office phone, in this example (i.e., that the user is in an environment where his/her office phone is available for use), rather than tracking the user's location (e.g., via GPS coordinates). Location change service 300 may then send messages 603 and/or 604 for validating that the <phone tag ID> belongs to the user, for example. It may save the user's current status (e.g., presence state, personal agent rules, etc.), update their presence state to “In the Office,” and change their personal agent settings to switch incoming calls and messages to the desk phone (or apply other preselected call route settings).

In some implementations, message 603 may contain a <user's SIP ID> and a <new location ID> that identifies the user and their new active location. In turn, SIP AS 302 may use the <new location ID> to retrieve a <profile ID> from the SIP AS user profile database, and it may return <profile ID> to Location Change service 300 (not shown). Also, message 604 to Personal Agent 301 may contain the <user's SIP ID> and <profile ID> (thus identifying the user and their newly activated persona profile). Personal Agent 301 may retrieve the rules (previously provisioned) associated with this profile, and it may then apply them to SIP AS 302 (not shown). Then, Location Change service 300 sends message 605 to the user's smartphone (e.g., communication device 102) to provide an acknowledgement. For example, in response to receiving the acknowledgement message 605, the client application may, in certain embodiments, display (via GUI module 203) a visual indicator (e.g., color change, icon, etc.) on the smartphone's display to indicate that the user is now in “office” mode.

When the user leaves their office, the reverse procedure may be performed, again as illustrated with respect to repeating the operations shown in FIG. 6. Particularly, the user may hold their phone against the NFC sticker on or near their desk phone (triggering message(s) 601).

Using messages 601, the client application executing on the user's smartphone may read the <phone tag ID> from the NFC tag, validate that it belongs to the user, and it may present the user with a device selection menu. In contrast with the previous example, however, here the user may select an option to “Enable Mobile Phone.” The client application may send the <phone tag ID> to notify the Location Change service 300 about the change of location (message 602) that, again, may be a change relative to the proximity to the user's office desk phone, as opposed to a GPS-type tracking of the user's location. The Location Change service may validate that the <phone tag ID> belongs to the user, and it may restore the user's previous Personal Agent rules and presence state to default values or values in place when the user previously entered the office (messages 603 and/or 604). At this point, the desktop phone may be no longer active for incoming features (e.g., as defined by Personal Agent rules). In certain embodiments, the desktop phone may remain active for calls directed to it, but it may no longer be active for other types of services, such as receipt of calls directed to the user's smartphone, etc. Then, a Location Change acknowledgement may be sent to the client application (message 605), which in turn may display a visual indicator that the user has returned to “out-of-office” mode.

Additionally or alternatively, in some embodiments, if the user leaves work and forgets to touch NFC tag, for example, client application 200 may be invoked to manually disable the user's desk phone without the need for an NFC tag or other proximity device (e.g., a “Change to Mobile” GUI option). Also, instead of holding the mobile phone against the desk phone again when leaving the office, client application 200 may otherwise detect that it is no longer within certain proximity of the desk phone's proximity device (e.g., detect that the user has left his/her office), and it may autonomously implement procedures for redirecting calls to the user's mobile device.

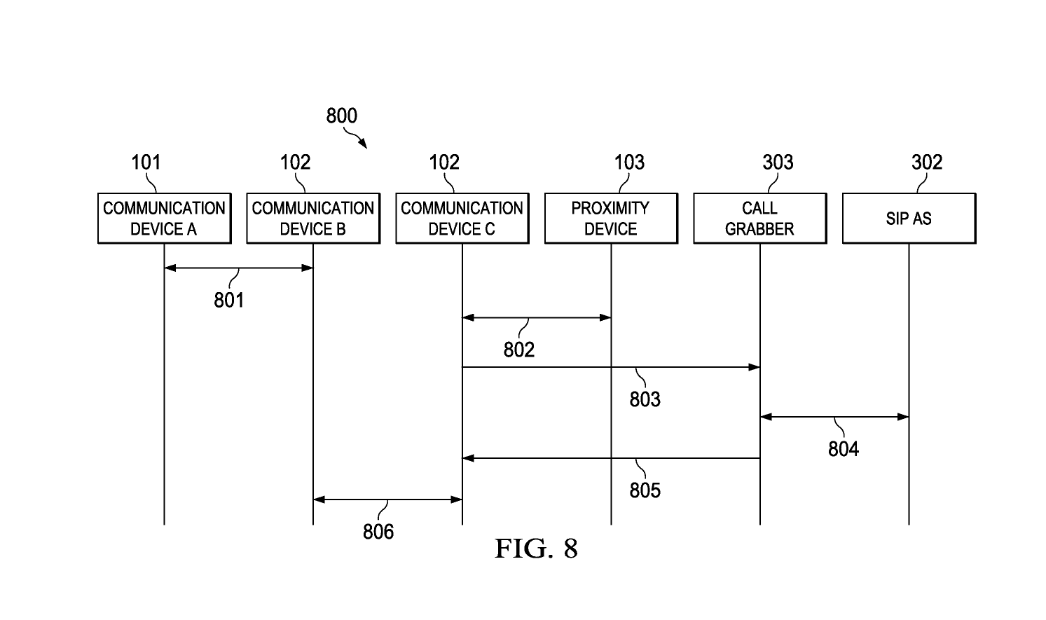

To illustrate an example of a call grabbing implementation, FIG. 8 shows a message flow diagram according to some embodiments. Particularly, message(s) 801 indicate that a user operating communication device A (e.g., an office phone) is in an ongoing communication (e.g., a telephone call) with a third party operating communication device B. For purposes of this example, suppose that the user of communication device A then decides to “grab” the communication with another communication device C (e.g., a mobile phone) while the communication is still in progress with communication device B. That is, the user of communication device A desires to migrate the call to communication device C, which he or she will then use to continue the communication with the user of communication device B. The user may then place his/her mobile phone next to a “Call Grabber Tag” (proximity device 103) located on or near communication device C. For instance, in the scenario of FIG. 7, if the user of the smartphone had a call in progress on their smartphone when he or she entered their office and touched the smartphone to the office phone, then a “Call Grabber” one-touch option may have been presented on the user's smartphone for migrating the current call to the office phone (or the client application may have been pre-configured to automatically perform this type of migration to the office phone). The client application 200 executing on the communication device C may read, via message(s) 802, a <device ID> (e.g., the identification code portion of the configuration information stored in the NFC tag) and Call Grab <service ID> (e.g., the service code portion of the configuration information stored in the NFC tag) from the proximity device 103 (e.g., tag).

The client application executing on communication device C may then send, via message(s) 803, the <device ID>, Call Grab <service ID>, and an identification of communication device C (e.g., the user's mobile phone) to the call Grab Service (e.g., element 303 shown in FIG. 3). In some cases, by using the mobile phone's Directory Number (DN) as its identification, it may be possible for any SIP subscriber with a NFC phone to grab the call. As reflected by message(s) 804, the Call Grab service may use the <device ID> to identify the user's desk phone (i.e., communication device A) and to identify the active call. A SIP AS server (e.g., element 302 in FIG. 3) may put the call leg with the third party (i.e., with communication device B in this example) on hold and break the call leg with the user's desk phone (i.e., communication device A). Then, the SIP AS server may establish a new call leg with the user's mobile phone (i.e., communication device C in this example), and may join this leg to the original call (i.e., between communication devices A and B) at message 805. As reflected by messages 806, the call leg with communication device B may be taken off-hold and communication devices B and C are now in communication with each other. As can be seen by this example, in certain embodiments such call grabbing or call migration services can be performed efficiently with minimal (or no) interaction required of the user.

In some embodiments, a call grabbing service may be configured so as to grab a call at a desk phone that was originally in progress with the user's mobile phone. In this case, upon touching the user's mobile phone (on which the call is in progress) to an NFC tag at the desk phone, a location change service may initiate the call grabbing operation on behalf of the office phone. A SIP AS server may put the grabbed leg on hold and drop the call leg with the user's mobile phone as it creates a call leg with user's desk phone. The desk phone may ring to allow the user to answer it, after which the SIP AS server may join the desk phone leg to the previous call and take it off hold. For instance, following the example with FIG. 7, if a call is in progress on the mobile phone at the time the user enters his office and touches his mobile phone to the desk phone's proximity device, the GUI 203 may present an option on the user's mobile phone to provide a one-touch option for migrating the current call to the desk phone.

To illustrate an example of a teleconference implementation in accordance with certain embodiments, consider the following illustrative scenario. As a user enters a conference room, a teleconferencing system (e.g., a speaker phone, etc.) may be arranged on the conference room's table with an NFC tag attached to it or positioned nearby. The user's mobile phone may read a <phone tag ID> from the NFC tag, which may trigger the GUI module 203 of the client application executing on the user's mobile phone to present the user with a “Join Conference” menu, in response to which the user may select the “join” option. The client application may also read a <service id> (communicated to the user's mobile device by the proximity device) to determine that the user is requesting the teleconferencing service, and it may send the <phone tag ID> and user's identification (e.g., an MSISDN, etc.) to a teleconferencing service (e.g., element 304 in FIG. 3).

The teleconferencing service may use the user's identification to identify and retrieve the user's calendar or other database (e.g., element 305 in FIG. 3), which may store conference bridge and passcode information for a scheduled conference. As such, the teleconferencing service may use the retrieved conference bridge information to join or setup the teleconference. A SIP AS server may also use a <device id> or the like to retrieve the telephone number of the teleconferencing system, and it may join the teleconferencing system to the conference call with little or no manual user input. In this manner, a user may schedule a teleconference that is then stored to the calendar database (with the user's call-in bridge information, passcode for joining the teleconference, security ID/password, etc.) and the teleconferencing service may trigger the setup of the teleconference with little to no input of this information by the user (as opposed to the traditional techniques that require the user to manually key-in all of this information to setup the conference call)

In other implementations, the systems and methods described herein may be used to detect or verify that a user is currently driving a car or other vehicle in order to redirect (e.g., to voicemail, to another communication device, etc.) or buffer (e.g., text messages, email, etc.) certain communications and to minimize disruption to the user and/or others in a given environment. For example, upon receipt of a communication request or event (e.g., phone call, e-mail message, Short Messaging Service or SMS, instant message, video call, file transfer, image transfer, etc.), a client application 200 executing on a user's mobile communication device may detect that the user of the mobile communication device is in a “driving” condition (e.g., by detecting that the user's mobile phone is near the driver's seat of a car via one or more NFC tags installed in a suitable location within the car (e.g., in a driver's seat or door, steering wheel, etc.) and without relying upon alternative context indicator(s) (e.g., detection of a Bluetooth® connection associated with the car's hands free unit, a motion sensor in the mobile communication device, the use GPS to detect motion and speed, or a manual setting by the user). to determine that the user is driving the car. Such detection may be performed, for instance, at the mobile device directly, with a proximity device or other the communication network equipment probing the mobile device, by getting a periodic updates from the mobile device of its current status, etc. In other cases, one or more of the aforementioned alternative context indicator(s) may be used to determine the driving condition, and an NFC tab may be used to direct all or some of the communications to another device, such as to a passenger's mobile communication device (e.g., by touching the passenger's phone to another NFC tag located in the passenger's seat, door, glove compartment, etc.).

Upon determining that the user is driving the vehicle, one or more of elements 300-305 shown in FIG. 3 may operate to implement one or more telecommunication techniques operations such as, for example, redirecting all calls to voicemail, blocking reception of messages (e.g., until delivery is possible or safe), sending or playing an automated message back to the initiator indicating that “the user is driving,” etc. In some cases, an incoming telephone call may be redirected calls to an Interactive Voice Response (IVR) system or the like. The IVR system may ask the caller if their call is urgent, in which case the call may be allowed to go through. Similarly, when an incoming request is already flagged as urgent, the communication request will be allowed in spite of the recipient's driving condition. Additionally or alternatively, if another mobile communication device is determined to be nearest a passenger seat or the like (e.g., through the use of the same or another NFC tag or proximity device located near or in the passenger's seat), one or more of elements 300-305 shown in FIG. 3 may operate to temporarily forward calls and messages (or at least urgent calls and messages) targeting the driver's device to the passenger's device.

In yet other embodiments, the systems and methods described herein may also be used to enable new categories of “flash-mob communications” and/or social network “check-ins.” For example, when a user enters a sports arena or stadium, a shopping mall, etc., notifying other persons of the user's location is not practical with existing communication technologies (e.g., GPS, etc.). In some implementations, however, NFC devices or other proximity devices may be distributed within or across a particular environment (e.g., attached to designated areas, seats, etc.) to allow a user to make his or her communication device interact with a given NFC device and transmit a check-in message or the like to predefined communication groups (e.g., a selected portion of the user's social network). For instance, the check-in message may include a location of the NFC device (and thus the location of the user) such that the user's friends may more easily find him or her in that environment using their own communication devices (e.g., the user's location may be displayed on a map of the arena, etc.).

While the examples described above discuss specific types of telecommunication management actions that may be performed using proximity-based technologies (e.g., call redirection, call grabbing, teleconferencing, etc.), management of various other types of telecommunication services may be similarly performed based on proximity-based technologies, as will be readily understood by a person of ordinary skill in the art light of this specification. Moreover, management of various non-telecommunication services may also be performed based on the same or similar proximity-based technologies.

In the case of non-telecommunication services, a proximity device need not be associated with any other particular device (e.g., it may be located near the door a user's house, office, etc.) and/or it may be associated with two or more devices. For example, upon entering his or her home, a user may scan an NFC tag and automatically set his or her preferences with respect to the house's environmental systems (e.g., furnace, air conditioner, humidifier, etc.) by automatically managing a thermostat or other similar device. As a result of the same NFC scanning operation, a home automation system may automatically configure one or more lighting device, house appliances (e.g., turning on a coffee maker, dish washer, etc.), office appliances (e.g., logging into a computer, configuring and/or starting software applications executable by a computer, etc.), or the like.

For example, if a user is watching a video on their smartphone while on a flight or airport, and upon arriving home he or she swipes an NFC tag located in their living room. This swiping action may trigger several non-telecommunication services across different devices, including, for example, turning on the TV, transferring the video stream from the smartphone to the TV, adjusting the thermostat to control room temperature, and/or displaying an interactive TV guide for the evening on the user's tablet computer. In some cases, these management operations may depend, for example, upon a time, day, or month when the scanning takes place. Additionally or alternatively, these operations may depend upon other types of information (e.g., the outside temperature, whether it is day or night, what programs are being broadcast at that time, etc.). Upon leaving the living room, the user may again scan the same (or a different NFC) tag to turn of one or more of these services. Additionally or alternatively, these services may be managed manually as previously described.

As noted above, embodiments of systems and methods for managing telecommunication and/or non-telecommunication services using proximity-based technologies may be implemented or executed, at least in part, by one or more computer systems. One such system is illustrated in FIG. 9. In various embodiments, system 900 may be a server, a workstation, a desktop computer, a laptop, a tablet computer, a mobile device, a smart phone, or the like. In some cases, system 900 may be used to implement communication devices 101 and/or 102, and application server(s) 105 shown in FIG. 1. As illustrated, computer system 900 includes one or more processor(s) 910A-N coupled to a system memory 920 via an input/output (I/O) interface 930. Computer system 900 further includes a network interface 940 coupled to I/O interface 930, and one or more input/output devices 950, such as proximity device(s) 103 (e.g., a Bluetooth® adaptor, a Wifi adaptor, or the like), keyboard 970, and display(s) 980.

In various embodiments, computer system 900 may be a single-processor system including one processor 910A (e.g., processor 201 shown in FIG. 2), or a multi-processor system including two or more processors 910A-N (e.g., two, four, eight, or another suitable number). Processor(s) 910A-N may include any processor capable of executing program instructions. For example, in various embodiments, processor(s) 910A-N may be general-purpose or embedded processors implementing any of a variety of instruction set architectures (ISAs), such as the x86, PowerPC®, ARM®, SPARC®, or MIPS® ISAs, or any other suitable ISA. In multi-processor systems, each of processor(s) 910A-N may commonly, but not necessarily, implement the same ISA. Also, in some embodiments, at least one processor 910A may be a graphics processing unit (GPU) or other dedicated graphics-rendering device.

System memory 920 may be configured to store program instructions (e.g., software application 200 shown in FIG. 2) and/or data accessible by processor(s) 910A-N. In various embodiments, system memory 920 may be implemented using any suitable memory technology, such as static random access memory (SRAM), synchronous dynamic RAM (SDRAM), nonvolatile/Flash-type memory, or any other type of memory. As illustrated, program instructions and data implementing certain operations such as, for example, those described in connection with FIGS. 4-8, may be stored within system memory 920 as program instructions 925 and data storage 935, respectively. Additionally or alternatively, client application 200 shown in FIG. 2 may be a software program that is stored within system memory 920 and is executable by processor(s) 910A-N. In other embodiments, program instructions and/or data may be received, sent or stored upon different types of computer-accessible media or on similar media separate from system memory 920 or computer system 900. Generally speaking, a computer-accessible medium may include any tangible or non-transitory storage media or memory media such as electronic, magnetic, or optical media—e.g., disk or CD/DVD-ROM coupled to computer system 900 via I/O interface 930. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, I/O interface 930 may be configured to coordinate I/O traffic between processor(s) 910A-N, system memory 920, and any peripheral devices in the device, including network interface 940 or other peripheral interfaces, such as input/output devices 950. In some embodiments, I/O interface 930 may perform any necessary protocol, timing or other data transformations to convert data signals from one component (e.g., system memory 920) into a format suitable for use by another component (e.g., processor(s) 910A-N). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. In addition, in some embodiments some or all of the functionality of I/O interface 930, such as an interface to system memory 920, may be incorporated directly into processor(s) 910A-N.

Network interface 940 may be configured to allow data to be exchanged between computer system 900 and other devices attached to a network (e.g., telecommunications network 104 of FIG. 1), such as other computer systems, or between nodes of computer system 900. In various embodiments, network interface 940 may support communication via wired or wireless general data networks, such as any suitable type of Ethernet network, for example; via telecommunications/telephony networks such as analog voice networks or digital fiber communications networks; via storage area networks such as FibreChannel SANs, or via any other suitable type of network and/or protocol.

Input/output devices 950 may, in some embodiments, include one or more display terminals, keyboards, keypads, touchpads, scanning devices, RFID readers, NFC readers, voice or optical recognition devices, or any other devices suitable for entering or retrieving data by one or more computer system 900. Multiple input/output devices 950 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 940.

As shown in FIG. 9, memory 920 may include program instructions 925, configured to implement certain embodiments described herein, and data storage 935, comprising various data may be accessible by program instructions 925. In an embodiment, program instructions 925 may include software elements of embodiments illustrated in the above figures. For example, program instructions 925 may be implemented in various embodiments using any desired programming language, scripting language, or combination of programming languages and/or scripting languages (e.g., C, C++, C#, Java™, JavaScript™, Perl, etc.). Data storage 935 may include data that may be used in these embodiments (e.g., recorded communications, profiles for different modes of operations, etc.). In other embodiments, other or different software elements and data may be included.

A person of ordinary skill in the art will appreciate that computer system 900 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system or processor-based configurations.

Although certain embodiments are described herein with reference to specific examples, numerous modifications and changes may be made in light of the foregoing description. Accordingly, the specification and figures are to be regarded in an illustrative rather than a restrictive sense, and all such modifications are intended to be included within their scope. Any benefits, advantages, or solutions to problems that are described herein with regard to specific embodiments are not to be construed as a critical, required, or essential feature or element of any or all the claims. Furthermore, it should be understood that the various operations described herein may be implemented in software, hardware, or a combination thereof. The order in which each operation of a given technique is performed may be changed, and the elements of the systems illustrated herein may be added, reordered, combined, omitted, modified, etc. It is intended that the embodiments described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The term “coupled” is defined as “connected” and/or “in communication with,” although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
detecting, by a first communication device, a proximity device coupled to or integrated within a second communication device; and
triggering an operation configured to manage a telecommunication service based, at least in part, upon the detection of the proximity device.

2. The method of claim 1, wherein the first communication device includes a laptop computer, a netbook computer, a tablet computer, a cellular phone, or a smartphone, and wherein the proximity device includes a Radio-Frequency Identification (RFID) or a Near Field Communications (NFC) tag.

3. The method of claim 1, wherein the operation is configured to reduce a number of manual operations that would otherwise be involved in managing the telecommunication service.

4. The method of claim 1, wherein the operation is configured to cause a routing of a communication directed at the first communication device to the second communication device.

5. The method of claim 4, wherein the communication is in progress via the first communication device at a time prior to the first communication device detecting the proximity device, and wherein the communication continues via the second communication device after the routing.

6. The method of claim 4, further comprising:
causing the routing to cease, at least in part, in response to an event selected from the group consisting of: a determination that the first communication device no longer detects the proximity device, and a subsequent detection by the first communication device of the proximity device, and a manual selection by a user of the first communication device.

7. The method of claim 4, wherein the proximity device is located in a vehicle, wherein the first communication device is located closer to a driver's position within the vehicle than the second communication device, and wherein the second communication device is located closer to a passenger position in the vehicle than the first communication device.

8. The method of claim 1, wherein the operation is configured to cause a routing of a communication directed at the second communication device to the first communication device.

9. The method of claim 8, wherein the communication is in progress via the second communication device at a time prior to the first communication device detecting the proximity device, and wherein the communication continues via the first communication device after the routing.

10. The method of claim 1, wherein the operation is configured to cause the one or more application servers to retrieve conference call information associated with a user of the first communication device, the conference call information including a conference bridge and passcode, and wherein the operation is further configured to cause the one or more application servers to cause a conference call to be established via the second communication device using the conference bridge and passcode.

11. The method of claim 1, wherein detecting the proximity device further comprises:
receiving telecommunication configuration information from the proximity device, the telecommunication configuration information including an identification code and a service code.

12. The method of claim 11, wherein triggering the operation further comprises:
causing the identification code to be validated against at least one piece of information selected from the group consisting of: an identification of the first communication device, an identification of a user of the first communication device, and an identification of the second communication device; and
transmitting the service code to one or more application servers remotely located with respect to the first communication device, the service code configured to manage an aspect of the telecommunications service provided, at least in part, by the one or more application servers.

13. The method of claim 12, wherein to cause the identification code to be validated, the method further comprises:
transmitting the identification code and the selected piece(s) of information to the one or more application servers, the one or more application services configured to attempt to match the identification code to the selected piece(s) of information.

14. A communication device having a processor and a memory coupled to the processor, the memory configured to store program instructions executable by the processor to cause the communication device to:
detect a proximity device; and
trigger an operation configured to manage a telecommunication service based, at least in part, upon the detection of the proximity device.

15. The communication device of claim 14, wherein the telecommunication service includes a service provided by a social network to a user of the communication device, and wherein the operation includes transmitting a message indicating a physical location of the user to one or more of the user's contacts in the social network based, at least in part, upon a physical location of the proximity device.

16. The communication device of claim 14, wherein the program instructions executable by the processor to cause the communication device to:
trigger another operation configured to manage a non-telecommunication service based, at least in part, upon the detection of the proximity device.

17. The communication device of claim 14, wherein the non-telecommunication service is provided by an entity selected from the group consisting of: an environmental system, a lighting device, a house appliance, and an office appliance.

18. The communication device of claim 14, wherein the non-telecommunication service includes a visual interface provided by an entity selected from the group consisting of: a television, a computer, a netbook, a tablet computer, and a smart phone.

19. A tangible computer-readable storage medium having program instructions stored thereon that, upon execution by a computer system, cause the computer system to:
receive telecommunication configuration information from a mobile communication device, the telecommunication configuration information obtained by the mobile communication device from a proximity device located within range of the mobile communication device, the mobile communication device and the proximity device remotely located with respect to the computer system, the telecommunication configuration information including a service code and an identification code; and
modify of an aspect of a telecommunications service provided to the mobile communication device based, at least in part, upon the service code and the identification code, wherein the service code is configured to reduce a number of operations by the user of the mobile communication device that would otherwise be involved in the modification.

20. The tangible computer-readable storage medium of claim 19, wherein to modify the aspect of the telecommunication service, the program instructions further cause the computer system to request that a communication directed at the mobile communication device be routed to another communication device.

21. The tangible computer-readable storage medium of claim 19, wherein to modify the aspect of the telecommunication service, the program instructions further cause the computer system to request that a communication directed at another communication device be routed to the mobile communication device.

22. The tangible computer-readable storage medium of claim 19, wherein to modify the aspect of the telecommunication service, the program instructions further cause the computer system to request (a) retrieval of conference call information associated with a user of the mobile communication device, and (b) establishment of a conference call via another communication device using the conference call information.

23. A proximity device, comprising:
a memory configured to store telecommunication configuration information, the telecommunication configuration information including an identification code and a service code, the identification code and the service code retrievable by a communication device within range of the proximity device, the identification code usable by the communication device to validate at least one piece of information selected from the group consisting of: an identification of the communication device and an identification of a user of the communication device, the service code configured to cause a modification of an aspect of a telecommunications service provided at least in part by one or more application servers to the communication device, the one or more application servers remotely located with respect to the communication device.

24. The proximity device of claim 23, wherein the service code is configured to cause the one or more application servers to route a communication directed at the communication device to another communication device without manual input from the user of the communication device, or to cause the one or more application servers to route a communication directed at the other communication device to the communication device without manual input from the user of the communication device.

25. The proximity device of claim 23, wherein the service code is configured to cause the one or more application servers to retrieve conference call information associated with the user of the communication device and to cause the one or more application servers to establish a conference call via another communication device using the conference bridge and passcode without manual input from the user of the communication device.
